(19) United States
(12) Patent Application Publication
(10) Pub. No.: US 2024/0166207 A1
(43) Pub. Date: May 23, 2024

(54) VEHICLE SPEED CONTROL METHOD

(71) Applicant: TOYOTA JIDOSHA KABUSHIKI KAISHA, Toyota-shi (JP)

(72) Inventor: Yuko YOSHIDA, Toyota-shi (JP)

(73) Assignee: TOYOTA JIDOSHA KABUSHIKI KAISHA, Toyota-shi (JP)

(21) Appl. No.: 18/508,950

(22) Filed: Nov. 14, 2023

(30) Foreign Application Priority Data
Nov. 18, 2022 (JP) 2022-184608

(51) Int. Cl. B60W 30/14; B60W 30/18

(52) U.S. Cl. CPC B60W 30/143; B60W 30/18159; B60W 2552/30; B60W 2554/404

(57) ABSTRACT

A vehicle speed control method includes: a calculation step of calculating a first vehicle speed when a vehicle moves in a roundabout, on the basis of curvature information indicating curvature related to the roundabout; a first control step of bringing a vehicle speed of the vehicle close to a second vehicle speed that is lower than the first vehicle speed, when the vehicle enters the roundabout; and a second control step of bringing the vehicle speed of the vehicle close to the first vehicle speed, after the vehicle enters the roundabout.

### INCORPORATION BY REFERENCE

This application is based upon and claims the benefit of priority from Japanese Patent Application No. 2022-184608, filed on Nov. 18, 2022, the disclosure of which is incorporated herein in its entirety by reference.

### TECHNICAL FIELD

Embodiments of this disclosure relate to technical fields of a vehicle speed control method.

### BACKGROUND ART

A proposed method of this type of method, for example, is a method of calculating a radius of curvature of a plurality of consecutive positions on the basis of map information represented by a combination of nodes and links, and of controlling a braking force of a vehicle on the basis of the calculated radius of curvature (see Japanese Patent No. 5821959 as Patent Literature 1).

In the method described in Patent Literature 1, of the plurality of consecutive positions, a position at which a difference in the radius of curvature is greater than or equal to a set value, is excluded. Therefore, for example, a position corresponding to an entrance of a roundabout is excluded from a calculation target of the radius of curvature. That is, Patent Literature 1 does not disclose a vehicle speed control when the vehicle enters the roundabout, which is technically problematic.

### SUMMARY

In view of the above-described problems, it is an object of this disclosure to provide a vehicle speed control method that allows a proper vehicle speed control when a vehicle enters a roundabout.

A vehicle speed control method according to an aspect of this disclosure includes: a calculation step of calculating a first vehicle speed when a vehicle moves in a roundabout, on the basis of curvature information indicating curvature related to the roundabout; a first control step of bringing a vehicle speed of the vehicle close to a second vehicle speed that is lower than the first vehicle speed, when the vehicle enters the roundabout; and a second control step of bringing the vehicle speed of the vehicle close to the first vehicle speed, after the vehicle enters the roundabout.

### BRIEF DESCRIPTION OF THE DRAWINGS

FIG. 1 is a block diagram illustrating a configuration of a vehicle according to a first embodiment

FIG. 2 is a diagram illustrating an example of a roundabout;

FIG. 3 is a flowchart illustrating operation of the vehicle according to the first embodiment;

FIG. 4 is a diagram illustrating another example of the roundabout; and

FIG. 5 is a flowchart illustrating operation of the vehicle according to the second embodiment.

### EMBODIMENTS

A vehicle speed control method according to embodiments of this disclosure will be described with reference to the drawings.

### First Embodiment

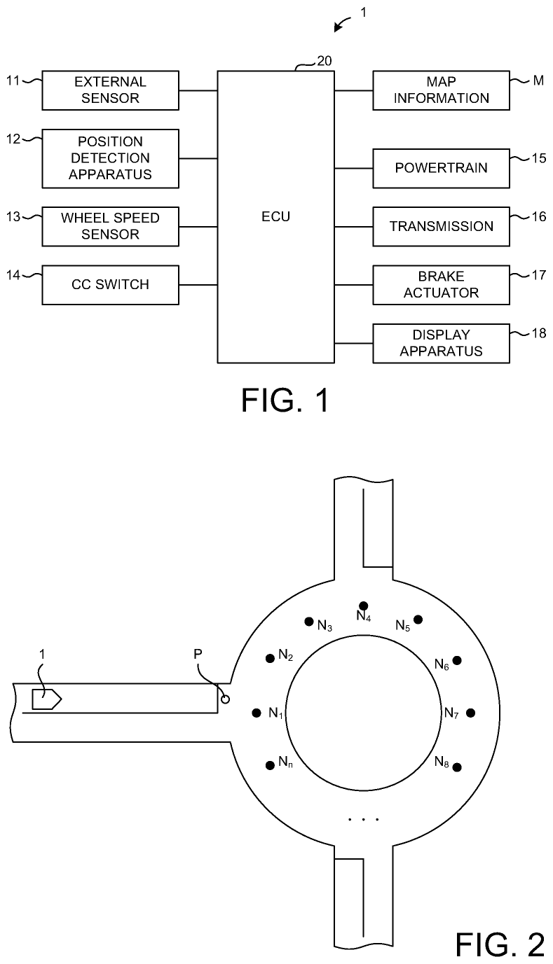

A vehicle speed control method according to a first embodiment will be described with reference to FIG. 1 to FIG. 3.

A vehicle 1 to which the vehicle speed control method according to the first embodiment is applied will be described with reference to FIG. 1. In FIG. 1, the vehicle 1 includes an external sensor 11, a position detection apparatus 12, a wheel speed sensor 13, a cruise control switch 14, a powertrain 15, a transmission 16, a brake actuator 17, a display apparatus 18, and an Electronic Control Unit (ECU) 20. The cruise control switch 14 will be hereinafter referred to as a “CC switch 14”, as appropriate.

The external sensor 11 is a sensor that detects a situation around the vehicle 1 (e.g., an obstacle, another vehicle, a pedestrian, a structure, a road shape, etc.). The external sensor 11 may include at least one of a camera that images a scene ahead of a vehicle, a radar sensor, and a LiDER (Light Detection and Ranging, Laser Imaging Detection and Ranging).

The position detection apparatus 12 detects a position of the vehicle 1. For example, the position detection apparatus 12 may detect the position of the vehicle 1 by receiving radio waves emitted from GPS (Global Positioning System) satellites.

The CC switch 14 is a unit for a driver of the vehicle 1 to set a cruise control. That is, the vehicle 1 is a vehicle having a cruise control function. The cruise control function is not limited to a function of controlling a vehicle speed of the vehicle 1, but may include a function of controlling a distance between the vehicle 1 and a preceding vehicle of the vehicle 1 (i.e., may be an adaptive cruise control). When the cruise control function of the vehicle 1 is a cruise control for all the vehicle speeds, the CC switch 14 may be a unit for obtaining a start intention of the driver.

The display apparatus 18 displays at least one of a condition related to the cruise control (e.g., at least one of a set vehicle speed and a set inter-vehicle distance) and a current control state, when the cruise control function is ON. The display apparatus 18 may be a display disposed in an instrument panel of the vehicle 1.

The vehicle 1 includes a single ECU 20. The vehicle, however, may include a plurality of ECUs. In this instance, the vehicle 1 may include at least two of an ECU having the cruise control function, an ECU for controlling the powertrain 15 and the transmission 16, an ECU for controlling the brake actuator 17, an ECU for controlling the display apparatus 18, and an ECU related to multimedia.

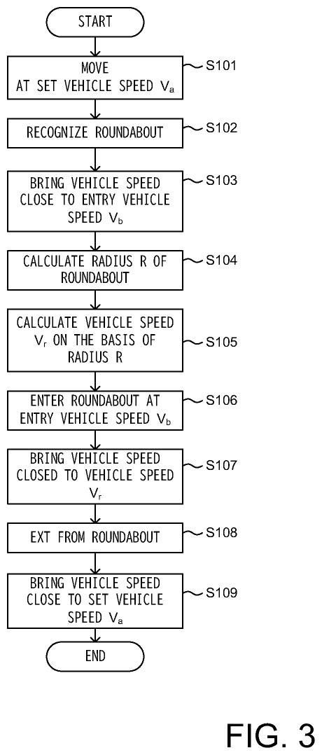

A vehicle speed control method when the vehicle 1 configured as described above moves in a roundabout, will be described with reference to FIG. 2 and FIG. 3. Hereinafter, an aspect in which the above vehicle speed control method is realized by the cruise control function will be described. The vehicle speed control method may be realized by a function or a system that allows an acceleration/deceleration control of the vehicle 1 such that the vehicle 1 moves at the set vehicle speed (or target vehicle speed), as well as by the cruise control function.

As illustrated in FIG. 2, the vehicle 1 shall enter the roundabout from a left side in FIG. 2. The vehicle 1 may move counterclockwise in the roundabout, move toward an upper side in FIG. 2, and exit from the roundabout (i.e., turn left). The vehicle 1 may move counterclockwise in the roundabout, move toward a lower side in FIG. 2, and exit from the roundabout (i.e., turn right). The vehicle 1 may move counterclockwise in the roundabout, move toward a left side in FIG. 2, and exit from the roundabout (i.e., make a U-turn). The vehicle 1 is steered by the driver operating a not-illustrated steering wheel of the vehicle 1.

Here, map information M (see FIG. 1) includes information about the roundabout. The map information M may be, for example, map information represented by a combination of nodes and links. In FIG. 2, a black circle indicates at least a part of a plurality of nodes N₁ to Nₙ that represent the roundabout and that are included in the map information M. Each node may be associated with a curvature value of a road. The plurality of nodes N₁ to Nₙ shall be associated with curvature values a₁ to aₙ.

In FIG. 3, when the cruise control function is ON, the ECU 20 of the vehicle 1 controls at least one of the powertrain 15, the transmission 16, and the brake actuator 17, on the basis of an output of the wheel speed sensor 13 such that the vehicle speed of the vehicle 1 approaches (typically, matches) a set vehicle speed Va set by the driver of the vehicle 1. Consequently, the vehicle 1 moves at the set vehicle speed Va (or a vehicle speed that is as close to the set vehicle speed Va as possible) (step S101).

When the vehicle 1 is moving, the ECU 20 may identify the position of the vehicle 1 on a map, on the basis of a detection result (e.g., a road shape) of the detection by the external sensor 11, the position of the vehicle 1 detected by the position detection apparatus 12, and the map information M. When the ECU 20 recognizes the roundabout ahead of the vehicle 1 from the map information M (step S102), the ECU 20 changes the target vehicle speed of the vehicle 1 from the set vehicle speed Va to an entry vehicle speed Vb. The entry vehicle speed Vb is a vehicle speed of the vehicle 1 when the vehicle 1 enters the roundabout. The entry vehicle speed Vb is lower than the set vehicle speed Va. The entry vehicle speed Vb may be equivalent to the target vehicle speed of the vehicle 1 at a point P (see FIG. 2) near an entrance of the roundabout.

The ECU 20 controls at least one of the powertrain 15, the transmission 16, and the brake actuator 17, on the basis of the output of the wheel speed sensor 13 such that the vehicle speed of the vehicle 1 approaches (typically, matches) the entry vehicle speed Vb (step S103).

In parallel with the step S103, the ECU 20 calculates a radius R of the roundabout from the map information M (step S104). Specifically, the ECU 20 may obtain the curvature values associated with at least a part of the plurality of nodes N₁ to Nₙ representing the roundabout. When the vehicle 1 exits from the roundabout towards the upper side in FIG. 2, the ECU 20 may obtain, for example, curvature values a₁ to a₃ respectively associated with nodes N₁ to N₃. When the vehicle 1 exits from the roundabout toward the lower side in FIG. 2, the ECU 20 may obtain, for example, curvature values a to as respectively associated with nodes N₁ to N₈. When the vehicle 1 exits from the roundabout towards the left side in FIG. 2, the ECU 20 may obtain, for example, the curvature values a₁ to aₙ respectively associated with the nodes N₁ to Nₙ. The ECU 20 may obtain the curvature values a₁ to aₙ respectively associated with the nodes N₁ to Nₙ, regardless of a direction of exiting from the roundabout. The ECU 20 may calculate an average value aₐᵥₑ of the obtained curvature values. The ECU 20 may calculate an inverse of the average value aₐᵥₑ (i.e., “1/aₐᵥₑ”) as the radius R.

The ECU 20 calculates a vehicle speed Vᵣ when the vehicle 1 moves in the roundabout, on the basis of the radius R (step S105). The vehicle speed Vᵣ is lower than the set vehicle speed Vₐ and is higher than the entry vehicle speed V_{b}. For example, the ECU 20 may calculate the vehicle speed Vᵣ on the basis of a map that defines a relationship between the radius R and the vehicle speed Vᵣ. The ECU 20 may calculate the vehicle speed Vᵣ on the basis of a function in which the radius R is used as a variable.

After the vehicle 1 enters the roundabout at the entry vehicle speed V_{b} (or a vehicle speed that is as close to the entry vehicle speed V_{b} as possible) due to the step S103 (step S106), the ECU 20 controls at least one of the powertrain 15, the transmission 16, and the brake actuator 17, on the basis of the output of the wheel speed sensor 13 such that the vehicle speed of the vehicle 1 approaches (typically, matches) the vehicle speed Vᵣ (step S107).

When the vehicle 1 exits from the roundabout (step S108), the ECU 20 controls at least one of the powertrain 15, the transmission 16 and the brake actuator 17, on the basis of the output of the wheel speed sensor 13 such that the vehicle 1 speed approaches (typically, matches) the set vehicle speed Vₐ (step S109). Consequently, the vehicle 1 moves in the roundabout at the vehicle speed Vᵣ (or a vehicle speed that is as close to the vehicle speed Vᵣ as possible).

As described above, the entry vehicle speed V_{b} is lower than the set vehicle speed Vₐ and the vehicle speed Vᵣ is higher than the entry vehicle speed V_{b}. Therefore, before entering the roundabout, the vehicle 1 decelerates from the set vehicle speed Vₐ to the entry vehicle speed V_{b}. When the vehicle 1 enters the roundabout, the vehicle 1 accelerates from the entry vehicle speed V_{b} to the vehicle speed Vᵣ. Furthermore, the set vehicle speed Vₐ is higher than the vehicle speed Vᵣ. Therefore, when the vehicle 1 exits from the roundabout, the vehicle 1 accelerates from the vehicle speed Vᵣ to the set vehicle speed Vₐ.

### (Technical Effect)

When a driver operates a vehicle (e.g., the vehicle 1) to move in the roundabout, the driver determines the vehicle speed in accordance with actual situations, such as a size of the roundabout and a flow of traffic. Therefore, when the vehicle 1 moves in the roundabout by the cruise control function, it is hard to determine in advance the vehicle speed (corresponding to the vehicle speed Vᵣ described above) of the vehicle 1 in the roundabout, which is technically problematic.

In contrast, in this embodiment, it is possible to calculate the vehicle speed Vᵣ on the basis of the radius R of the roundabout before the vehicle 1 that moves by the cruise control function enters the roundabout. It can be said that the radius R of the roundabout is an index representing the size of the roundabout. For this reason, it can be expected that the vehicle speed Vᵣ based on the radius R of the roundabout is a vehicle speed that is close to the vehicle speed determined by the driver in accordance with the size of the roundabout. Therefore, it can be said that the driver less likely feels strange when the vehicle 1 moves in the roundabout at the vehicle speed Vᵣ by the cruise control function. That is, according to this embodiment, when the vehicle 1 moves in the roundabout by the cruise control function, it is possible to properly determine in advance the vehicle speed Vᵣ of the vehicle 1 in the roundabout.

As described above, Patent Literature 1 has such a technical problem that it does not disclose the vehicle speed control when the vehicle enters the roundabout. In this embodiment, before entering the roundabout, the vehicle 1 decelerates from the set vehicle speed Vₐ to the entry vehicle speed V_{b}. When the vehicle 1 enters the roundabout, the vehicle 1 accelerates from the entry vehicle speed V_{b} to the vehicle speed Vᵣ. Therefore, according to this embodiment, it is possible to properly perform the vehicle speed control when the vehicle 1 enters the roundabout.

### Second Embodiment

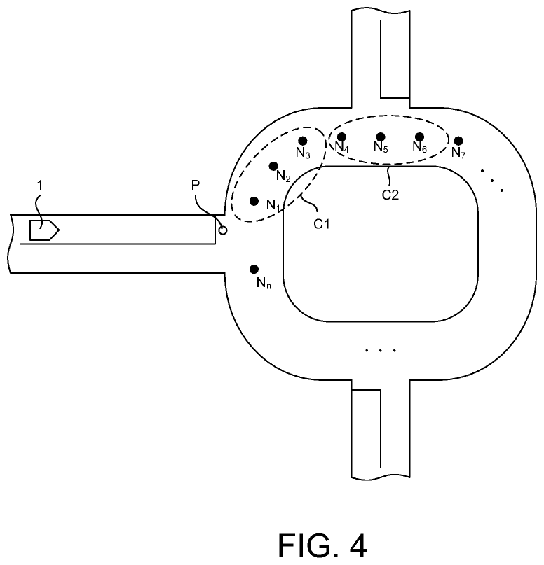

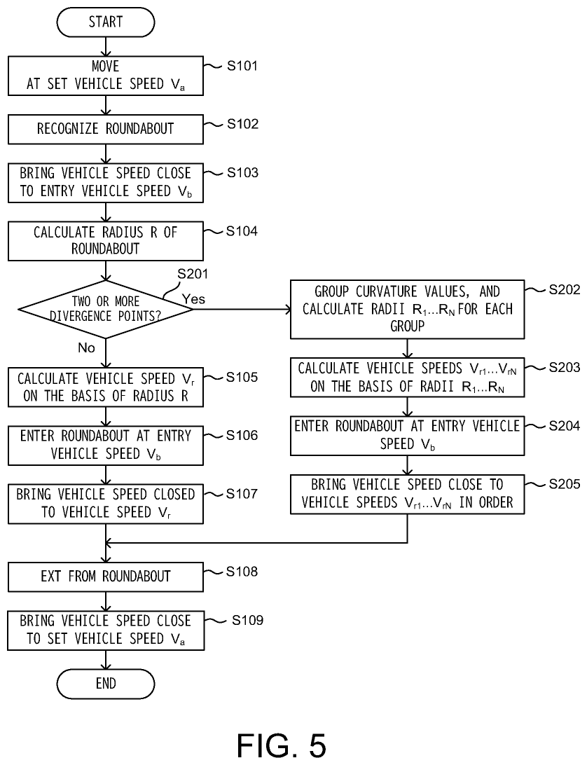

A vehicle speed control method according to a second embodiment will be described with reference to FIG. 4 and FIG. 5. The second embodiment is the same as the first embodiment, except that the operation of the vehicle 1 (specifically, the ECU 20) is partially different. For this reason, in the second embodiment, a description that overlaps with the description of the first embodiment will be omitted, and a common part on the drawings is denoted by the same reference numeral. Only basically different points will be described with reference to FIG. 4 and FIG. 5.

The roundabout includes not only those having a shape close to a perfect circle (see FIG. 2), but also those having a shape different from the perfect circle, such as those partially including a straight line (see FIG. 4). The ECU 20 of the vehicle 1 may determine whether or not the roundabout has a shape close to the perfect circle shape, on the basis of the average value aₐᵥₑ of the curvature values used to calculate the radius R, in the step S104.

In FIG. 5, after the step S104, the ECU 20 determines whether there are two or more nodes associated with the curvature values that deviate from the average value aₐᵥₑ of the curvature values (step S201). The “nodes associated with curvature values that deviate from the average value aₐᵥₑ of curvature values” may be referred to as “divergence points.” When a difference between the curvature value associated with the node and the average value aₐᵥₑ is greater than a predetermined value, the ECU 20 may determine that the curvature value deviates from the average value aₐᵥₑ. On the other hand, when the difference between the curvature value associated with the node and the average value aₐᵥₑ is less than the predetermined value, the ECU 20 may determine that the curvature value does not deviate from the average value aₐᵥₑ. A case where the difference is equal to the predetermined value, may be included and treated in one of the above two situations.

The predetermined value may be determined as appropriate, for example, on the basis of a design concept of the vehicle speed control, a speed limit of a road, or the like. For example, when the vehicle speed (corresponding to the vehicle speed Vᵣ) when the vehicle 1 moves in a roundabout with a curvature value of “ 1/20” is the same as the vehicle speed (corresponding to the vehicle speed Vᵣ) when the vehicle 1 moves in a roundabout with a curvature value of “ 1/45”, there is no need to distinguish between the two in vehicle speed control. In this case, the predetermined value may be set such that it is determined that the curvature value of “ 1/20” and the curvature value of “ 1/45” do not deviate from each other. For example, when the vehicle speed (corresponding to the vehicle speed Vᵣ) when the vehicle 1 moves in the roundabout with a curvature value of “ 1/20” is different from the vehicle speed (corresponding to the vehicle speed Vᵣ) when the vehicle 1 moves in the roundabout with a curvature value of “ 1/45”, it is necessary to distinguish between the two in vehicle speed control. In this case, the predetermined value may be set such that it is determined that the curvature value of “ 1/20” and the curvature value of “ 1/45” deviate from each other.

In the step S201, when it is determined that there are not two or more nodes associated with the curvature values that deviate from the average value aₐᵥₑ of the curvature values (step S201: No), the ECU 20 performs the step S105. That is, in this instance, it can be said that the ECU 20 determines that the shape of the roundabout is close to the perfect circle.

In the step S201, when it is determined that there are two or more nodes associated with the curvature values that deviate from the average value aₐᵥₑ of the curvature values (step S201: Yes), the ECU 20 groups at least a part of the plurality of nodes N₁ to Nₙ representing the roundabout, by the curvature value. That is, it can be said that the ECU 20 determines that the shape of the roundabout is not close to the perfect circle. The ECU 20 may group two or more nodes representing a section where the vehicle 1 moves, of the plurality of nodes N₁ to Nₙ, by the curvature value. The ECU 20 may group all the plurality of nodes N₁ to Nₙ, by the curvature value.

In FIG. 4, the vehicle 1 moves counterclockwise in the roundabout. For example, the ECU 20 may calculate the average value of the curvature value a₁ associated with the node N₁ and the curvature value a₂ associated with the node N₂. The ECU 20 may compare the calculated average value with the curvature value a₃ associated with the node N₃. When the curvature value a₃ does not deviate from the average value of the curvature values a₁ and a₂, the ECU 20 may classify the node N₃ into the same group as the nodes N₁ and N₂. On the other hand, when the curvature value a₃ deviates from the average value of the curvature values a₁ and a₂, the ECU 20 may classify the node N₃ into a different group from the nodes N₁ and N₂. In this instance, the ECU 20 may calculate the average value of the curvature value a₃ associated with the node N₃ and the curvature value a₄ associated with the node N₄. The ECU 20 may compare the calculated average value with the curvature value as associated with the node N₅.

In FIG. 4, it is assumed that the nodes N₁ to N₃ surrounded by a broken line circle C1 is classified into one group, and the nodes N₄ to N₆ surrounded by a broken line circle C2 is classified into another group. For convenience, FIG. 4 illustrates only two groups. In contrast, in FIG. 5, at least a part of the plurality of nodes N₁ to Nₙ is classified into N groups (where, N≥2).

The ECU 20 may calculate the average value of the curvature values for each group. Then, the ECU 20 calculates radii R₁ to R_{N} for each group, on the basis of the calculated average value of the curvature values (step S202). For example, for the group including the nodes N₁ to N₃, the ECU 20 may calculate the average value of the curvature values a₁ to a₃ associated with the nodes N₁ to N₃, and may calculate the radius R₁ on the basis of the calculated average value of the curvature values. For example, for the group including the nodes N₄ to N₆, the ECU 20 may calculate the average value of the curvature values a₄ to a₆ associated with the nodes N₄ to N₆, and may calculate the radius R₂ on the basis of the calculated average value of the curvature values.

The ECU 20 calculates vehicle speeds Vr₁ to V_{rN} when the vehicle 1 moves in the roundabout, on the basis of the radii R₁ to R_{N} calculated in the step S202 (step S203). Here, the v vehicle speeds Vᵣ₁ to V_{rN} may be associated with the nodes.

After the vehicle 1 enters the roundabout at the entry vehicle speed V_{b} (or a vehicle speed that is as close to the entry vehicle speed V_{b} as possible) due to the step S103 (step S204), the ECU 20 controls at least one of the powertrain 15, the transmission 16, and the brake actuator 17, on the basis of the output of the wheel speed sensor 13 such that the vehicle speed of the vehicle 1 approaches (typically, matches) any of the vehicle speeds Vr₁ to V_{rN}, in accordance with the position of the vehicle 1 in the roundabout (step S205). Consequently, the vehicle speed of the vehicle 1 in the roundabout changes in the order of the vehicle speeds Vᵣ₁, Vᵣ₂, . . . , V_{rN}.

### (Technical Effect)

According to this embodiment, it is possible to calculate an appropriate vehicle speed (e.g., Vr₁ to V_{rN}) in accordance with a change in the curvature values of a road that constitutes the roundabout. As a result, the vehicle 1 that moves by the cruise control function is capable of moving in the roundabout at the appropriate vehicle speed corresponding to the shape of the roundabout.

Aspects of this disclosure derived from the embodiments described above will be described below.

A vehicle speed control method according to an aspect of this disclosure includes: a calculation step of calculating a first vehicle speed when a vehicle moves in a roundabout, on the basis of curvature information indicating curvature related to the roundabout; a first control step of bringing a vehicle speed of the vehicle close to a second vehicle speed that is lower than the first vehicle speed, when the vehicle enters the roundabout; and a second control step of bringing the vehicle speed of the vehicle close to the first vehicle speed, after the vehicle enters the roundabout. In the above-described embodiments, the “vehicle speed Vᵣ” and the “vehicle speed Vᵣ₁ to V_{rN}” correspond to an example of the “first vehicle speed”, and the “entry vehicle speed V_{b}” corresponds to an example of the “second vehicle speed”.

The curvature information may include a plurality of curvature values corresponding respectively to a plurality of points in the roundabout, the vehicle speed control method may include a division step of dividing the roundabout into at least two sections on the basis of the plurality of curvature values, when the plurality of points include two or more points, each of which has a curvature value that deviates from an average value of the plurality of curvature values, and the calculating step may calculate a vehicle speed when the vehicle moves in each of the at least two sections, as the first vehicle speed.

The vehicle speed control method may include a third control step of bringing the vehicle speed of the vehicle close to a third vehicle speed that is higher than the first vehicle speed, after the vehicle exits from the roundabout. In the above-described embodiments, the “set vehicle speed Vₐ” corresponds to an example of the “third vehicle speed”.

The calculation step may calculate a radius of the roundabout on the basis of the curvature information, and may calculate the first vehicle speed on the basis of the calculated radius.

This disclosure is not limited to the above-described examples and is allowed to be changed, if desired, without departing from the essence or spirit of the invention which can be read from the claims and the entire specification. A vehicle speed control method with such changes is also included in the technical concepts of this disclosure.

### DESCRIPTION OF REFERENCE NUMERALS

1 . . . vehicle, 11 . . . external sensor, 12 . . . position detection apparatus, 13 . . . wheel speed sensor, 14 . . . cruise control switch, 15 . . . powertrain, 16 . . . transmission, 17 . . . brake actuator, 18 . . . display apparatus, 20 . . . ECU

What is claimed is:

1. A vehicle speed control method comprising:
a calculation step of calculating a first vehicle speed when a vehicle moves in a roundabout, on the basis of curvature information indicating curvature related to the roundabout;
a first control step of bringing a vehicle speed of the vehicle close to a second vehicle speed that is lower than the first vehicle speed, when the vehicle enters the roundabout; and
a second control step of bringing the vehicle speed of the vehicle close to the first vehicle speed, after the vehicle enters the roundabout.

2. The vehicle speed control method according to claim 1, wherein
the curvature information includes a plurality of curvature values corresponding respectively to a plurality of points in the roundabout,
the vehicle speed control method comprises a division step of dividing the roundabout into at least two sections on the basis of the plurality of curvature values, when the plurality of points include two or more points, each of which has a curvature value that deviates from an average value of the plurality of curvature values, and
the calculating step calculates a vehicle speed when the vehicle moves in each of the at least two sections, as the first vehicle speed.

3. The vehicle speed control method according to claim 1, further comprising a third control step of bringing the vehicle speed of the vehicle close to a third vehicle speed that is higher than the first vehicle speed, after the vehicle exits from the roundabout

4. The vehicle speed control method according to claim 1, wherein the calculation step calculates a radius of the roundabout on the basis of the curvature information, and calculates the first vehicle speed on the basis of the calculated radius.
